(19) United States
(12) Patent Application Publication
(10) Pub. No.: US 2026/0146692 A1
(43) Pub. Date: May 28, 2026

(54) SLEEVE JOINT FOR PIPES

(71) Applicant: ALPE PIPE SYSTEMS GMBH & CO. KG, Stams (AT)

(72) Inventor: Reinhold MAURER, Innsbruck (AT)

(21) Appl. No.: 19/104,109

(22) PCT Filed: Aug. 17, 2022
(86) PCT No.: PCT/EP2022/072969

§ 371 Date: Feb. 14, 2025

(51) Int. Cl. F16L 21/08; F16L 37/14

(52) U.S. Cl. CPC F16L 21/08; F16L 37/142

(57) ABSTRACT

The invention relates to a sleeve joint and, in particular, to a pipe fitting for a sleeve joint between two steel pipes. The pipe fitting has a sleeve that has a bar receiving space for receiving a sealing ring. The bar receiving space is delimited at the end face by an inwardly projecting end wall against which a mating contact surface extending at the corresponding angle can bear against a respective bar.

The invention relates to a sleeve joint for pipes.

It is known to connect pipes to each other at their longitudinal ends using a sleeve joint. In this case, a sleeve grips an axial end of a pipe and a seal or a material-bonded joint between the sleeve and pipe end creates a liquid-tight connection.

Sleeve joints are known from DE 200 22 897 U 1 and WO 2014/053216A 1 , in which a spigot or insertion end of a first pipe is inserted into a pipe end of a second pipe designed as a sleeve and the sleeve joint is secured in the axial direction with the aid of movable bars. The sleeve end of the second pipe has a circumferential collar that projects radially inwards and has openings in the circumferential direction through which a respective bar can be inserted, so that the respective bar can then be displaced in a tangential direction and supported on the collar of the sleeve in the axial direction. A bead extending in the circumferential direction, e.g. a welding bead, can be provided at the insertion or seating end of the first pipe, on which the respective bar can also be supported in the axial direction of the pipes, so that the respective bar is located in the longitudinal direction of the sleeve joint between the collar of the sleeve on the second pipe and the bead on the spigot or insertion end of the first pipe.

To create a sleeve joint, the spigot or insertion end of the first pipe is first inserted into the sleeve on the second pipe. The bars are then inserted into the inside of the sleeve through a respective opening in the collar on the sleeve until they rest against the bead on the insertion end of the second pipe and then moved radially to the left or right until a projection of the retaining bar rests against an edge of the respective opening in the collar of the sleeve on the second pipe.

The inwardly projecting collar, which defines the end face of the sleeve, has an inclined contact surface on the side facing the respective bar in the axial direction of the pipe, against which the respective bar rests with an equally inclined end face. The inwardly projecting collar of the sleeve defines a circumferential bar receiving space.

In addition, the pipe end in the form of a sleeve has a circumferential sealing chamber, which is separated from the bar receiving space by a separating wall that also projects radially inwards. A sealing ring is arranged in the sealing chamber, which serves to seal the sleeve joint and, as a result, rests against both the inner wall of the sealing chamber and the outer wall of the pipe end of the first pipe inserted into the sleeve. The separating wall between the bar receiving space and the sealing chamber prevents the sealing ring from being pushed out of the sleeve.

Longitudinal tensile forces between the pipes connected by the sleeve joint are absorbed by the bead on the first pipe, the collar of the sleeve on the second pipe and the bar there between.

The invention is based on the task of providing a sleeve joint for connecting two steel pipes, which is reliably tight and can transmit longitudinal tensile forces.

To solve this problem, a sleeve joint system is proposed which comprises a pipe fitting, several bars and two sealing rings.

The pipe fitting has two longitudinal ends and has a sleeve at each longitudinal end, into which an insertion end of a steel pipe can be inserted with a projection (e.g. a welding bead) that extends outwards at least in sections in the circumferential direction.

At its end face, each sleeve has a bar receiving space extending in a circumferential direction and a sealing chamber extending in a circumferential direction for receiving a sealing ring, which is separated from the bar receiving space by a circumferential separating wall.

The bar receiving space is limited at the end face by an inwardly projecting end wall, which is interrupted in the circumferential direction in such a way that it has insertion openings for inserting bars, the end wall having a conical contact surface running at an acute angle to the radial direction, against which a counter contact surface running at the corresponding angle can bear against a respective bar. In contrast to the prior art, the conical contact surface does not run at an obtuse angle to the radial seal of the sleeve, but at an acute angle. This means that the contact surface runs at an angle of less than 45° to a plane running at right angles to the longitudinal axis of the sleeve.

Starting from the separating wall, the sealing chamber initially tapers in the longitudinal direction of the pipe fitting and then widens again to accommodate a correspondingly shaped sealing ring, which at one longitudinal end has a radially outwardly extending retaining bead for contact with the separating wall and at the other longitudinal end has two sealing lips separated from each other in a dovetail or fork shape, which enclose an open-fronted intermediate space between them. The shapes of the sealing chamber and the associated sealing ring ensure on the one hand that the sealing ring cannot slip in the longitudinal direction of the sleeve joint even at high internal pressure and that the seal simultaneously seals reliably because the sealing lips are pressed apart by the pressure of a fluid, so that a radially outer sealing lip of the sealing ring lies tightly against a corresponding inner wall of the sealing chamber, while the radially inner sealing lip lies tightly against the outer surface of the respective steel pipe.

A sleeve joint is thus proposed for connecting a pipe to a pipe fitting, into the sleeve of which a spigot end of the pipe, which has a radially outwardly projecting projection, can be inserted. The sleeve of the pipe fitting has a radially inwardly projecting edge (namely the end wall of the bar receiving space) with two annular segment-shaped recesses (which form the insertion openings). A locking device for locking the spigot end in the sleeve of the pipe fitting comprises four ring-segment-shaped locking elements (the bars). In the locked state, the radially outwardly projecting projection of the pipe is supported on the locking elements and these on the end wall of the bar receiving space. A sealing ring for the sleeve joint is characterized by the fact that one part of the sealing ring is dovetailed and the opposite part has a radially outwardly extending retaining bead, whereby the first dovetailed part serves as the sealing part and the second bead-like part serves as the retaining part of the sealing ring.

The invention includes the realization that longitudinal ends of steel pipes-unlike longitudinal ends of cast iron pipes-cannot be formed as sleeves. Therefore, instead of a sleeve at one end of a pipe, a pipe fitting with two sleeves is provided. Steel pipes have the ad-vantage of being able to withstand a higher internal pressure. The invention includes the further realization that a higher internal pressure places higher demands on the longitudinal tensile forces to be transmitted by the sleeve joint and on the seal. In order to be able to transmit correspondingly high longitudinal tensile forces without the radial forces acting on the pipe fitting becoming too great, the angle of the conical contact surface was adapted accordingly and deviates from the dimension known from the prior art. The shape of the sealing chamber and the associated sealing ring were also designed differently from the prior art in order to provide a seal that is reliable even under high pressure, that is tight and where there is no risk of the sealing ring dislocating as a result of the pressure. The geometry of the conical contact surface for the bars on the end wall of the bar receiving chamber also plays a role with regard to the reliable seal, because the angle of the conical contact surface prevents excessive expansion of the pipe fitting and a potentially associated change in the geometry of the sealing chamber.

Preferably, the end wall of the bar receiving space of a sleeve has two receiving openings. Both a bar that can be moved counterclockwise and a bar that can be moved clockwise can then be inserted into the bar receiving space through a receiving opening.

Preferably, the contact surface on the end wall of the bar receiving space of a sleeve runs at an angle of between 30° and 40° in relation to a plane running perpendicular to the longitudinal axis of the sleeve. The contact surface on the end wall of the bar receiving space are then sections of a conical surface of a hollow cone with an obtuse tip angle.

The pipe fitting is preferably a cast part made of ductile cast iron. Depending on the application (low-pressure or high-pressure application), either an alloy according to GJS 400 or an alloy according to GJS 500 is used. Ductile cast iron is cast iron with spheroidal graphite and is therefore also known as globular gray cast iron or spheroidal graphite cast iron.

The bars are preferably also cast parts made of ductile cast iron, preferably GJS 400. Each bar has an arcuate bar section which has the mating contact surface which, after insertion of the bar, bears against the contact surface of the end wall of the bar receiving space of a sleeve. Depending on whether the bar is intended for clockwise or counterclockwise insertion, it has a projection at one or the other longitudinal end of its curved bar section, which serves to loosen a bar again and to remove it from the bar receiving space, particularly when the sleeve joint is released. This is because the respective projection of a bar is designed in such a way that the projection protrudes from the respective insertion opening when the respective bar is fully inserted into the bar receiving space and pushed into its final position.

In order to secure the bars against falling out after insertion and before the sleeve joint is placed under tension, elastic molded parts are preferably provided, which are attached between the projections on the bars inserted into the bar receiving space and pushed into their final position. A total of two elastic molded parts are provided for each sleeve. One elastic molded part is inserted between the two bars, which are inserted into the bar receiving space through the same insertion opening. The elastic molded parts are preferably made of ethylene propylene diene rubber (EDPM).

The seal is designed for the following operating conditions:
an operating temperature between 0° C. and 50° C.,
a maximum operating pressure of 100 bar and
a test pressure of 150 bar.

The seal can either be made of one material quality or two different material qualities. If the seal is made of two different material qualities, the area with the retaining bead is made of a harder material quality than the dovetail-like part, which performs the actual sealing function. The seal is preferably a sealing ring made of an elastomer, preferably ethylene propylene diene rubber (EPDM). Different sections of the sealing ring preferably have different hardnesses. In the area of the retaining bead, the hardness of the sealing ring is preferably between 75 and 95 Shore A, for example 85+/−5 Shore A, and in the area of the sealing lips, the hardness of the sealing ring is preferably between 40 and 60 Shore A, for example 55+/−5 Shore A.

A further aspect of the invention is a method of making a sleeve joint between two steel pipes by means of a pipe fitting, eight bars and two sealing rings of the type described above. The method comprises the steps of:
Inserting an insertion end of a first pipe into a first sleeve on the pipe fitting,
Inserting four bars into the bar receiving space of the first sleeve and moving the respective bar in such a way that the respective bar is located in the longitudinal direction of the sleeve joint between a radially outwardly projecting projection on the insertion end of the first pipe and an end wall of the bar receiving space of the first sleeve,
If necessary, insertion of elastic molded parts to secure the position of the bars
Inserting an insertion end of a second pipe into the second sleeve on the pipe fitting
Inserting four bars into the bar receiving space of the second sleeve and moving the respective bar in such a way that the respective bar is located in the longitudinal direction of the sleeve joint between a radially outwardly projecting projection on the insertion end of the second pipe and an end wall of the bar receiving space of the second sleeve,
If necessary, insertion of elastic molded parts to secure the position of the bars and
Stretching of the sleeve joint due to tension or internal pressure in the pipes.

A further aspect of the invention is a method of separating a sleeve joint between two steel pipes by means of a pipe fitting, eight bars and two sealing rings of the type described above. The method comprises the steps of:
releasing the clamping between the conical contact surface of the end wall of the bar receiving space, the bars and the projection projecting radially outwards at the spigot end of the pipe by pushing the spigot end of a pipe into the base of the sleeve using a laying device and
Remove the elastic molded parts if necessary
Grasping the bars at their projections, moving the bars and removing the bars from the bar receiving space of the sleeve of the pipe fitting through the insertion openings in the end wall of the bar receiving space.

The invention will now be explained in more detail by means of an embodiment example with reference to the figures. The figures show:

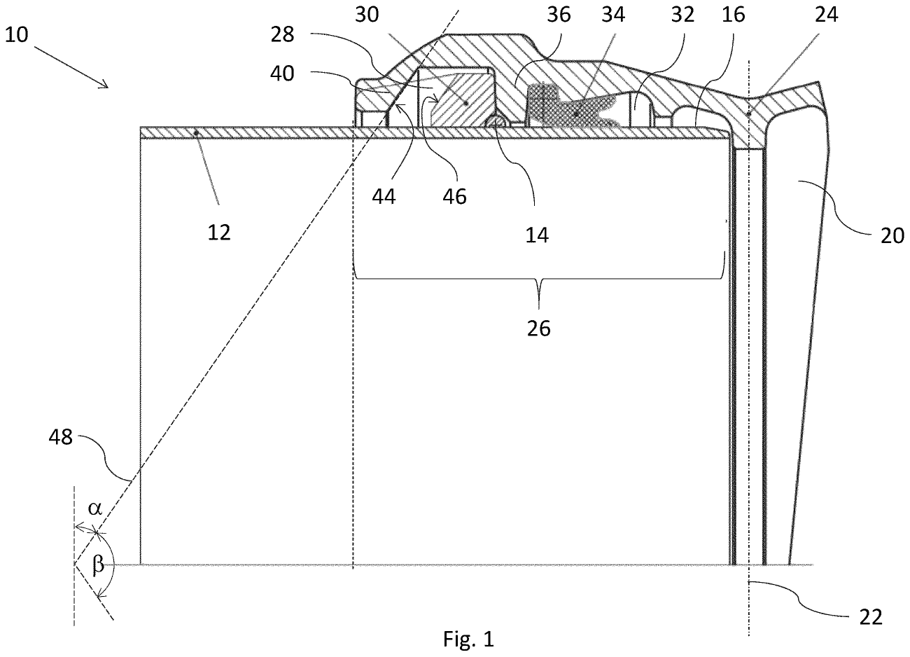

FIG. 1: A section of a longitudinal cut through a sleeve joint with a pipe fitting according to the invention and a sealing ring according to the invention;

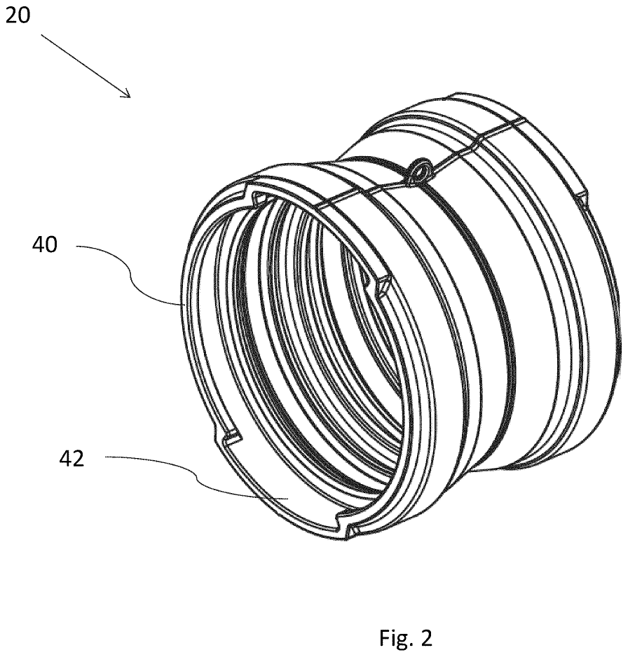

FIG. 2: A perspective view of the pipe fitting;

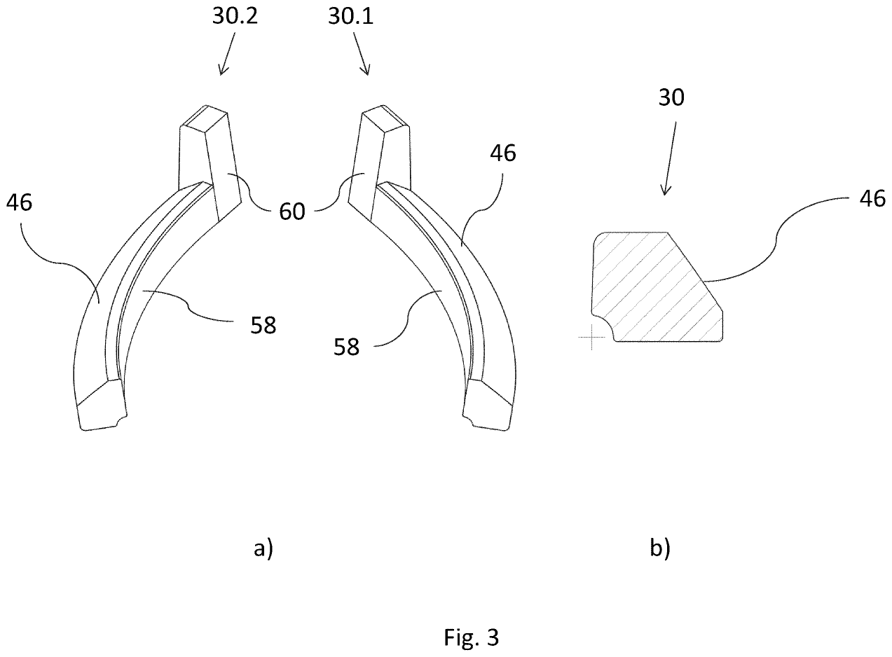

FIG. 3 a: A perspective view of a bar,

FIG. 3b: a cross-section through a bar; and

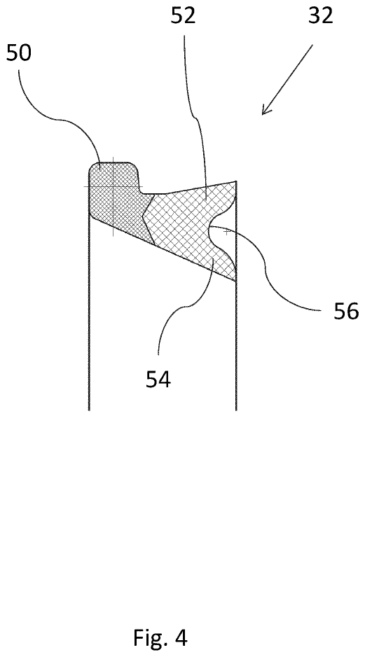

FIG. 4: An illustration of a sealing ring.

As can be seen from the preceding general description, the invention relates to a joint system for connecting the free ends of two steel pipes by means of a pipe fitting which has two sleeves, namely one sleeve at each longitudinal end of the pipe fitting. A section of such a joint system 10 is shown in FIG. 1. FIG. 1 shows a section of a free end of a steel pipe 12 with a circumferential outwardly projecting projection 14. The free end of the steel pipe 12 is designed as an insertion end 16.

In the example shown, the steel pipe 12 has a nominal diameter (DN) of 400 mm (DN 400). A standardized steel pipe with a nominal diameter of 400 mm, for example, has an outer diameter of 406.4 mm and, depending on the wall thickness, an inner diameter of between 392.2 mm (with a wall thickness of 7.1 mm) and 393.8 mm (with a wall thickness of 6.3 mm). The representation in FIG. 1 is approximately to scale, so that the dimensions and dimensional relationships can be taken at least approximately accurately from FIG. 1.

In alternative, advantageous design variants not shown, the steel pipe has a nominal diameter (DN) of 500 mm or 600 mm (DN 500 or DN 600). A standardized steel pipe DN 500 has an outer diameter of 508.0 mm. A standardized DN 600 steel pipe has an outer diameter of 610.0 mm.

In addition to the steel tube 12, FIG. 1 shows a section of a pipe fitting 20, which is symmetrical with respect to a central plane of symmetry 22 (indicated by the dotted line). The pipe fitting 20 has a central stop 24, which limits the insertion of a respective insertion end 16 of a steel pipe 12 in the axial direction. The central stop 24 encloses a central opening of the pipe fitting 20, the diameter of which is slightly smaller than the inside diameter of the steel pipe 12.

In relation to the longitudinal direction of the pipe fitting 20, it has a sleeve 26 on both sides of the central stop 24. In the example shown, the free end (the insertion end 16) of the steel pipe 12 is inserted into one of the sleeves 26.

Each of the two sleeves 26 of the pipe fitting 20 has a bar receiving space 28 at the end face—i.e. at the respective outwardly open longitudinal end of the pipe fitting 20—which serves to receive several bars 30, the functions of which are explained in more detail below.

In the longitudinal direction of the pipe fitting 20, between the circumferential bar receiving space 28 and the central stop 24, a circumferential sealing chamber 32 is provided, into which an annular seal 34—hereinafter also referred to as sealing ring 34—is inserted. The bar receiving space 28 and the sealing chamber 32 are separated from one another by a separating wall 36, which also runs around the circumference.

The bar receiving space 28 is bounded on the end face by a radially inwardly projecting end wall 40, which is interrupted in the circumferential direction in such a way that it has insertion openings 42 for inserting the bars 30. Where it is not interrupted by the insertion openings 42, the end wall 40 has a conical contact surface 44 extending at an acute angle to the radial direction, against which a mating contact surface 46 of a respective bar 30 extending at the corresponding angle can bear. As is generally known from the prior art, the respective bar receiving space 28 serves to receive bent bars 30 (see here also FIGS. 3a and 3b), which can be inserted into the bar receiving space 28 through the insertion openings 42 (see FIG. 2) and then be displaced in a tangential direction along the circumference of the insertion end 16 of the steel tube 12 in such a way that the respective bar can be supported against the contact surface 44 of the end wall 40 of the bar receiving space 28. On the other side (viewed in the longitudinal direction of the pipe fitting 20), each bar 30 can be supported on the radially outwardly projecting projection 14 on the tube 10, which the respective insertion end 16 of the steel tube 12 has. This outwardly projecting projection 14 can, for example, be a weld bead that is welded onto the outer lateral surface of the insertion end of the steel tube 12.

When an internal pressure prevails inside the line formed by the two steel pipes 12 and the pipe fitting 20 and the pipe joint system is stretched accordingly, a respective bar 30 rests with its mating contact surface 46 against the contact surface 44 of the end wall 40 of the pipe fitting 20. As can be seen in FIG. 1, both the contact surface 44 on the end wall 40 and the mating contact surface 46 on the respective bar 30 are each inclined at an acute angle to an imaginary cross-sectional plane extending perpendicular to the longitudinal axis of the pipe fitting 20. The contact surface 44 on the end wall 40 of the pipe fitting 20 and the mating contact surface 46 on the bar 30 thus each have the shape of a section of a cone or a section of a conical lateral surface. The associated cone has an obtuse tip angle β and is indicated by the dashed lines 48 in FIG. 1. In contrast to the prior art, the conical contact surface 44 therefore does not run at an obtuse angle to the radial direction of the sleeve, but at an acute angle. In other words, the contact surface 44 runs at an anglex of less than 45° to a plane running at right angles to the longitudinal axis of the sleeve.

Each bar 30 has an arcuate bar section 58 which has the mating contact surface 46 which, after insertion of the bar, rests against the contact surface 44 of the end wall 40 of the bar receiving space 28 of a sleeve 26. Depending on whether the bar 30 is intended to be inserted clockwise (bar 30.1) or counterclockwise (bar 30.2), it has a projection 60 (also referred to here as nose 60) at one or the other longitudinal end of its arcuate bar section 58, which serves in particular to loosen a bar 30 again and remove it from the bar receiving space 28 when the sleeve joint is released. This is because the respective projection 60 of a bar is designed such that the projection 60 protrudes from the respective insertion opening 42 when the respective bar 30 is fully inserted into the bar receiving space 28 and pushed to its final position.

In order to secure the bars 30 against falling out after insertion and before the sleeve joint is placed under tension, elastic molded parts made of ethylene-propylene-diene rubber (EPDM) are preferably provided, which are attached between the projections 60 on the bars 30 inserted into the bar receiving space 28 and pushed into their final position. A total of two elastic molded parts are provided for each sleeve 26. One elastic molded part is inserted between the two bars 30, which are inserted through the same insertion opening 42 into the bar receiving space 28. In principle, the elastic molded parts can be made of any elastomer.

Four bars 30 are provided for each sleeve 26, two of which are designed to slide in a counterclockwise direction and two of which are designed to slide in a clockwise direction. The end wall 40 of the respective sleeve therefore only needs to have two insertion openings 42. This is because one insertion opening 42 can be used to insert a bar 30 that can be displaced counterclockwise and a bar 30 that can be displaced clockwise. When inserted into the bar receiving space and displaced to their final position, the bars 30 are each in a position in which the bars 30 are diametrically opposite each other in pairs.

The pipe fitting 20 is a casting which is made of ductile cast iron, namely an alloy according to GJS 400 or an alloy according to GJS 500, depending on the application (low-pressure or high-pressure application). The bars 30 are preferably also castings which are made of ductile cast iron, preferably GJS 400.

The sealing chamber 32 is located between the bar receiving space 28 and the central stop 24. Starting from the separating wall 36, the sealing chamber 32 initially narrows in the longitudinal direction of the pipe fitting and then widens again in order to accommodate the correspondingly shaped sealing ring 34. At one longitudinal end, the sealing ring 34 has a radially outwardly extending retaining bead 50 for contact with the separating wall 36 and, at the other longitudinal end, two sealing lips 52 and 54 which are separated from each other in a fork-like manner and which enclose a space 56 between them which is open at the end face. The shapes of the sealing chamber 32 and the associated sealing ring 34 have the effect, on the one hand, that the sealing ring 34 cannot slip in the longitudinal direction of the sleeve joint even at high internal pressure and that the seal simultaneously seals reliably because the sealing lips 52 and 54 are pressed apart by the pressure of a fluid, so that a radially outer sealing lip 52 of the sealing ring 34 lies tightly against a corre-sponding inner wall of the sealing chamber 32, while the radially inner sealing lip 54 lies tightly against the outer casing surface of the respective steel pipe 10.

The sealing ring 34 is made of ethylene propylene diene rubber (EPDM) and has different hardnesses. In the area of the retaining bead 50, the hardness of the sealing ring is preferably 85+/−5 Shore A and in the area of the sealing lips 52 and 54, the hardness of the sealing ring is preferably 55+/−5 Shore A. In the cross-section of the sealing ring 34 shown in FIG. 4, the different hardnesses of the material of the sealing ring 34 are indicated by correspondingly different hatching.

To create a sleeve joint, the bars 30 serving as locking elements, two for each 180° of the pipe circumference, are inserted into the bar receiving space 28 through the annular segment-shaped insertion openings 42 in the end wall of the sleeve 26 of the pipe fitting. A total of four locking elements 30 are provided for the entire circumference of a sleeve joint.

As soon as the joint is pressurized or mechanically stretched, the locking elements 30 (the bars 30) are supported on the one hand on the radially outwardly projecting projection 14 at the spigot end 16 of the steel pipe 12 and on the other hand on the conical contact surface 44 of the end wall 40 of the bar receiving space 28 of the sleeve 26 of the pipe fitting 20. As a result, the sleeve joint is tension-proof.

To separate the sleeve joint, the spigot end 16 of the pipe 12 is pushed a few millimeters into the base of the sleeve using a laying tool, thereby releasing the clamping between the conical contact surface 44 of the end wall 40 of the bar receiving space 28, the bars 30 and the radially outwardly projecting projection 14 on the spigot end 16 of the steel pipe 12.

The bars 30 can now be gripped by their projections 60 (lugs) and moved in such a way that the bars 30 can be removed from the bar receiving space 28 of the sleeve 26 of the pipe fitting 20 through the annular segment-shaped recesses 42 serving as insertion openings.

Due to the special geometric shape of the conical end wall 40 of the bar receiving space 28 and the mating contact surfaces 46 on the bars 30, the longitudinal forces resulting from the internal pressure are transferred in the optimum direction to the weld bead forming the radially outwardly projecting projection 14.

### LIST OF REFERENCE SIGNS

10 Joint system
12 Steel tube
14 Projection projecting outwards
16 insertion end, spigot end
20 Pipe fitting
22 Plane of symmetry
24 Central stop
26 Sleeve
28 Bar receiving space
30 Bar
32 Sealing chamber
34 Sealing ring
36 Separating wall
40 End wall
42 Insertion openings
44 Contact surface
46 Counter contact surface
48 imaginary cone
50 Retaining bead
52 Outer sealing lip
54 Inner sealing lip
56 Intermediate open space between the outer and inner sealing lip
58 Arched bar section
60 Projection at the bar

1.-14. canceled

15. A pipe fitting for producing a sleeve joint between two steel pipes, the pipe fitting having two longitudinal ends and, at each longitudinal end, a sleeve into which an insertion end of a steel pipe with an outwardly projecting projection extending at least in sections in the circumferential direction can be inserted,
wherein each sleeve has on its end face a bar receiving space running around in the circumferential direction, as well as a sealing chamber for receiving a sealing ring, which is separated from the bar receiving space by a separating wall running around in the circumferential direction and also running around in the circumferential direction,
wherein the bar receiving space is bounded on the end face by an inwardly projecting end wall which is interrupted in the circumferential direction in such a way that it has insertion openings for the insertion of bars, wherein the end wall has a bearing surface which extends at an acute angle of less than 45° to the radial direction and against which a mating bearing surface extending at the corresponding angle can bear against a respective bar, and
wherein the sealing chamber, starting from the separating wall, initially tapers in the longitudinal direction of the pipe fitting and then widens again in order to accommodate a correspondingly shaped sealing ring, which has at one longitudinal end a radially outwardly extending retaining bead for abutment against the separating wall and at the other longitudinal end two sealing lips which are separated from one another in a fork-like manner and which enclose between them an intermediate space open at the end face.

16. The pipe fitting according to claim 15, in which the end wall of the bar receiving space of a sleeve has two receiving openings through which bars can be inserted into the respective bar receiving space.

17. The pipe fitting according to claim 15, in which the contact surface on the end wall of the bar receiving space of a sleeve is inclined at an angle of between 30° and 40° with respect to a plane extending perpendicular to the longitudinal axis of the sleeve.

18. The pipe fitting according to claim 15, wherein the pipe fitting is a ductile cast iron casting.

19. The pipe fitting according to claim 18, wherein the pipe fitting is a cast part made of GJS 400 or GJS 500.

20. A sealing ring for a pipe fitting according to claim 15, wherein the sealing ring has at one longitudinal end a radially outwardly extending retaining bead for abutment against the separating wall of the sealing chamber of the pipe fitting and at the other longitudinal end two sealing lips which are separated from one another in a fork-like manner and enclose between them an intermediate space open at the end faces
wherein the sealing lips are formed by an elastomer, preferably a rubber, with a Shore hardness between 40 and 60 Shore A and
the retaining bead has a Shore hardness of between 75 and 95 Shore A.

21. The sealing ring according to claim 20, which is one-piece and consists of ethylene-propylene-diene rubber.

22. The sealing ring for a pipe fitting according to claim 15, wherein the sealing ring has at one longitudinal end a radially outwardly extending retaining bead for abutment against the separating wall of the sealing chamber of the pipe fitting and at the other longitudinal end two sealing lips which are separated from one another in a fork-like manner and which enclose between them an intermediate space open at the end face,
wherein the sealing ring is in one piece and consists of ethylene-propylene-diene rubber and
the retaining bead has a Shore hardness between 75 and 95 Shore A.

23. The sleeve joint system with a pipe fitting according to claim 15, two sealing rings and eight bars for insertion into the bar receiving spaces and tangential displacement in the respective bar receiving space, wherein the sealing rings have at one longitudinal end a radially outwardly extending retaining bead for abutment against the separating wall of the sealing chamber of the pipe fitting and at the other longitudinal end two sealing lips which are separated from one another in a fork-like manner and which enclose between them an intermediate space which is open at the end face.

24. A method for producing a sleeve joint between two steel pipes by means of a pipe fitting according to claim 15, eight bars and two sealing rings, which have at one longitudinal end a radially outwardly extending retaining bead for abutment against the separating wall of the sealing chamber of the pipe fitting and at the other longitudinal end two sealing lips which are separated from one another in a fork-like manner and enclose between them an intermediate space which is open at the end face, comprising the steps of:
insertion of an insertion end of a first steel pipe into a first sleeve on the pipe fitting
inserting four bars into the bar receiving space of the first sleeve and displacing the respective bar in such a way that the respective bar is located in the longitudinal direction of the sleeve joint between a radially outwardly projecting projection on the insertion end of the first steel tube and an end wall of the bar receiving space of the first sleeve,
inserting an insertion end of a second steel pipe into the second sleeve on the pipe fitting
inserting four bars into the bar receiving space of the second sleeve and displacing the respective bar in such a way that the respective bar is located in the longitudinal direction of the sleeve joint between a radially outwardly projecting projection on the insertion end of the second steel pipe and an end wall of the bar receiving space of the second sleeve, and
Stretching the sleeve joint by tension or internal pressure in the steel pipes.

25. The method according to claim 24, in which, after the insertion and displacement of the bars, the position of the bars is secured by inserting resilient molded parts between the lugs of the bars.

26. A method of separating a sleeve joint between two steel pipes by means of a pipe fitting according to claim 15, eight bars 30 and two sealing rings, comprising the steps of:
releasing the clamping between the conical contact surface of the end wall of the bar receiving space, the bars and the radially outwardly projecting projection at the spigot end of the steel pipe by pushing the spigot end of a steel pipe into the base of the sleeve by means of a laying device and
gripping the bars at their projections, displacing the bars and removing the bars from the bar receiving space of the sleeve of the pipe fitting through the insertion openings in the end wall of the bar receiving space.

27. The method according to claim 26, in which resilient molded parts serving to secure the position of the bars are removed before the bars are displaced.
